(19) United States
(12) Patent Application Publication
(10) Pub. No.: US 2025/0337251 A1
(43) Pub. Date: Oct. 30, 2025

(54) DUAL ROLE POWER PACK AND METHOD

(71) Applicant: Cypress Semiconductor Corporation, San Jose, CA (US)

(72) Inventors: Shopitham RAM, San Jose, CA (US); Robert VARTANIAN, San Diego, CA (US); Anand KANNAN, Los Altos Hills, CA (US)

(73) Assignee: Cypress Semiconductor Corporation, San Jose, CA (US)

(21) Appl. No.: 18/649,685

(22) Filed: Apr. 29, 2024

(51) Int. Cl. H02J 7/00; H01M 10/42; H01M 10/48

(52) U.S. Cl. CPC H02J 7/00036; H01M 10/425; H01M 10/4285; H01M 10/482; H01M 10/486; H02J 7/00304; H02J 7/007182; H02J 7/007194; H01M 2010/4278; H02J 2207/30

(57) ABSTRACT

In an embodiment of the techniques presented herein, a system includes a universal serial bus (USB) port, a battery module, and a USB power delivery (USB-PD) controller. The battery module has a configuration memory configured to store battery module configuration data and a voltage sensor configured to generate a battery module voltage measurement. The USB-PD controller is configured to determine a maximum current discharge parameter based on the battery module voltage measurement and the battery module configuration data, determine a power delivery profile based on the maximum current discharge parameter, negotiate a power delivery contract with a device connected to the USB port based on the power delivery profile, and provide power from the battery module to the USB port based on the power delivery contract.

### BACKGROUND

Various electronic devices (e.g., such as battery packs, smartphones, tablets, notebook computers, laptop computers, hubs, chargers, adapters, etc.) are configured to transfer power through Universal Serial Bus (USB) connectors, for example, to deliver power through a USB Type-C connector according to a USB Power Delivery (USB-PD) protocol.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented herein, a system comprises a universal serial bus (USB) port, a battery module comprising a configuration memory configured to store battery module configuration data, and a voltage sensor configured to generate a battery module voltage measurement, and a USB power delivery (USB-PD) controller configured to determine a maximum current discharge parameter based on the battery module voltage measurement and the battery module configuration data, determine a power delivery profile based on the maximum current discharge parameter, negotiate a power delivery contract with a device connected to the USB port based on the power delivery profile, and discharge the battery module to provide power from the battery module to the USB port based on the power delivery contract.

In an embodiment of the techniques presented herein, a method for power delivery comprises receiving battery module configuration data from a configuration memory of a battery module, receiving a battery module voltage measurement from a voltage sensor, determining a maximum current discharge parameter based on the battery module voltage measurement and the battery module configuration data, determining a power delivery profile based on the maximum current discharge parameter, negotiating a power delivery contract with a device connected to a universal serial bus (USB) port based on the power delivery profile, and discharging the battery module to provide power from the battery module to the USB port based on the power delivery contract.

In an embodiment of the techniques presented herein, a universal serial bus power delivery (USB-PD) controller comprises a processing unit configured to receive battery module configuration data associated with a battery module, receive a battery module voltage measurement, determine a maximum current discharge parameter based on the battery module voltage measurement and the battery module configuration data, determine a power delivery profile based on the maximum current discharge parameter, negotiate a power delivery contract with a device connected to a universal serial bus (USB) port based on the power delivery profile, and cause discharge of the battery module to provide power from the battery module to the USB port based on the power delivery contract.

In an embodiment of the techniques presented herein, a system for power delivery comprises means for receiving battery module configuration data from a configuration memory of a battery module, means for receiving a battery module voltage measurement from a voltage sensor, means for determining a maximum current discharge parameter based on the battery module voltage measurement and the battery module configuration data, means for determining a power delivery profile based on the maximum current discharge parameter, means for negotiating a power delivery contract with a device connected to a universal serial bus (USB) port based on the power delivery profile, and means for discharging the battery module to provide power from the battery module to the USB port based on the power delivery contract.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram of a dual role power pack, in accordance with some embodiments.

FIG. 2 is a flowchart illustrating a method of operating a battery pack, in accordance with some embodiments.

FIG. 3 illustrates an exemplary embodiment of a system, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

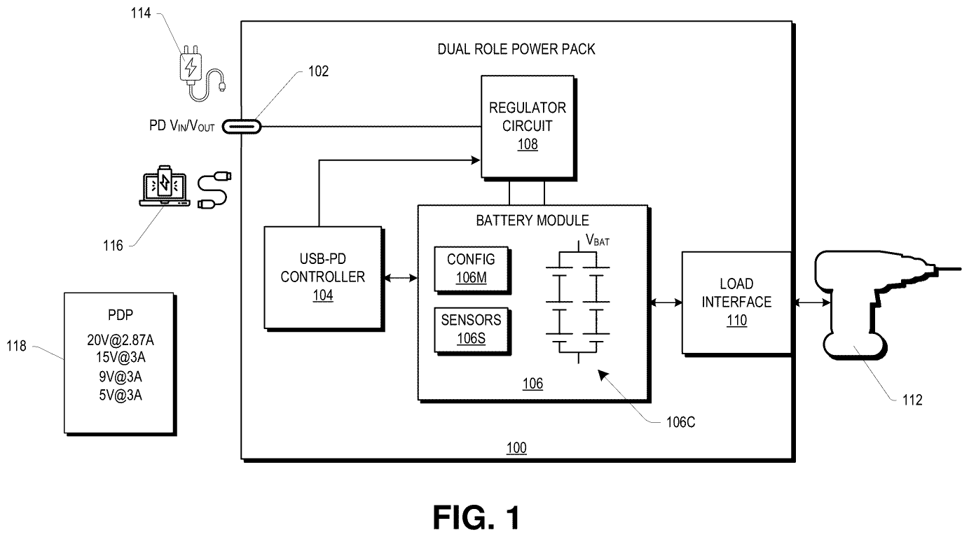

FIG. 1 is a block diagram illustrating at least some portions of a system, which may comprise a dual role power pack 100 in accordance with some embodiments. In some embodiments, the dual role power pack 100 comprises a universal serial bus (USB) port 102 (e.g., a USB type-C port), a USB power delivery (USB-PD) controller 104, a battery module 106, a regulator circuit 108, and a load interface 110. In some embodiments, the dual role power pack 100 delivers power from the battery module 106 to a load such as a power tool 112, through the load interface 110. For example, in a first role, the dual role power pack 100 may be attached to power tool 112 to power the tool during operation thereof; in a second role, the dual role power pack 100 may be used in a power delivery mode to charge an external device 116 (e.g., a smartphone or laptop) by discharging the battery module 106 through USB port 102. The USB port 102 may be used in a charging mode of the battery module 106 using a USB-PD adaptor 114 connected to the USB port 102 or in a power delivery mode of the battery module 106 for delivering power from the battery module 106 to an external device 116 connected to the USB port 102. In the charging mode, the USB-PD controller 104 may request a PD V_{IN} voltage from the USB-PD adaptor 114. In some embodiments, the regulator circuit 108 comprises a bypass circuit to provide the PD V_{IN} voltage directly to the battery cells 106C for charging. Alternatively, the USB-PD controller 104 may operate the regulator circuit 108 in a unity gain mode. In some embodiments, the regulator circuit 108 is integrated into the USB-PD controller 104. In some embodiments, the USB-PD controller 104 controls the regulator circuit 108 to regulate current, voltage, or both current and voltage.

In the power delivery mode, the USB-PD controller 104 negotiates a power delivery contract with the external device 116 for a requested PD V_{OUT}. The USB-PD controller 104 operates the regulator circuit 108 to step up (boost) or step down (buck) the voltage generated by the battery cells 106C to generate the requested PD V_{OUT}.

In some embodiments, the battery module 106 comprises battery cells 106C, a configuration memory (CONFIG) 106M, and one or more sensors 106S, such as a temperature sensor or a voltage sensor. In some embodiments, the configuration memory 106M stores battery module configuration data, such as a battery capacity (BCAP), a maximum charge current parameter (I_{MAX_CHG}), a maximum discharge current parameter (I_{MAX_DISCH}), a nominal discharge current parameter (I_{NOM_DISCH}), a regulator circuit efficiency parameter (ER), a number of battery cells connected in series per row parameter (N_{ROW}), nominal temperature range parameters (T_{MIN}, T_{MAX}), a temperature protection discharge multiplier (TP_{MULT}), or some other battery module parameter. The USB-PD controller 104 interfaces with the battery module 106 and uses the battery module configuration data in the configuration memory 106M and data from the sensors 106S to determine a power delivery profile (PDP) for negotiating a contract with the external device 116. Configuring the PDP based on the battery module configuration data allows smart discharging that extends the operating life and increases the performance of the battery module 106. In some embodiments, if the manufacturer does not specify certain battery module configuration data, default values may be used.

In some embodiments, the USB-PD controller 104 receives periodic battery module voltage measurements (V_{BAT}) and the battery module temperature (T_{BAT}). The USB-PD controller 104 determines a maximum source PDP (PDP_{MAX}) according to:

$$P D {P}_{MAX} = {V}_{BAT} \cdot {E}_{R} \cdot {I}_{MAX \_ DISCH} \cdot {N}_{ROW} \cdot T {P}_{MULT} , or \qquad ( 1 )$$

$$P D {P}_{MAX} = {V}_{BAT} \cdot {E}_{R} \cdot {I}_{NOM \_ DISCH} \cdot {N}_{ROW} \cdot T {P}_{MULT} . \qquad ( 2 )$$

In some embodiments, the use of the temperature protection discharge multiplier (TP_{MULT}) is determined based on the measured temperature of the temperature (T_{BAT}) of the battery module 106 from one of the sensors 106S to reduce the discharge current if the battery module 106 is cold or hot. The USB-PD controller 104 may use temperature thresholds (T_{MIN}, T_{MAX}) to determine the value of the temperature protection discharge multiplier (TP_{MULT}). The number of temperature thresholds and the associated temperature protection discharge multiplier (TP_{MULT}) for each threshold range may vary. In one example, one temperature window is defined for the battery module 106 according to:

$$T {P}_{MULT} = 1 ( if {T}_{MIN} < {T}_{BAT} < {T}_{MAX} ) and \qquad ( 3 )$$

$$T {P}_{MULT} = 0.5 C ( if not ( {T}_{MIN} < {T}_{BAT} < {T}_{MAX} ) ) . \qquad ( 4 )$$

In an example, T_{MIN} is 5° C. and T_{MAX} is 50° C. In some embodiments, discharging may be disabled if the measured temperature is less than 0° C. or greater than 50° C. A visual indicator may be provided on the battery module 106 to indicate the disabling of the discharging feature.

In some embodiments, the nominal discharge current (I_{NOM_DISCH}) is preferred over the maximum discharge current (I_{MAX_DISCH}) to promote longevity of the battery module 106. If the manufacturer provides a maximum discharge current, but not a nominal discharge current, the USB-PD controller 104 max use the maximum discharge current or a fractional multiple thereof.

Based on PDP_{MAX}, the USB-PD controller 104 determines source current and voltage for a set of advertised power delivery options (PDO) for the PDP at different PD V_{OUT} voltages according to:

$$20 V P D {V}_{OUT} : P D O = P D {P}_{MAX} / 20 V , \qquad ( 5 )$$

$$15 V P D {V}_{OUT} : P D O = P D {P}_{MAX} / 15 V , \qquad ( 6 )$$

$$9 V P D {V}_{OUT} : P D O = P D {P}_{MAX} / 9 V , or \qquad ( 7 )$$

$$5 V P D {V}_{OUT} : P D O = P D {P}_{MAX} / 5 V . \qquad ( 8 )$$

In some embodiments, the USB PD standard defines maximum current for a particular voltage. If the current calculated based on PDP_{MAX} is greater than the maximum defined by the PD standard, the standard value is used. In FIG. 1, a PDP 118 is illustrated for a battery module 106 with four battery cells 106C in one row, a maximum charge current (I_{MAX_CHG}) of 2600 mA (1C), a nominal discharge current (I_{NOM_DISCH}) of 4200 mA (1.61C), and a regulator circuit efficiency (ER) of 95%, and a battery module voltage measurement (V_{BAT}) from one of the sensors 106S of 14.4V according to:

$$P D {P}_{MAX} = 114 , 4 V \cdot 95 \% \cdot 4.2 A \cdot 1 row = 57.46 W and$$

$$P D O = 20 V @ 2.87 A , 15 V @ 3 A , 9 V @ 3 A , and 5 V \& 3 A$$

The advertised current may be up to 5A if supported by the USB Type-C cable. As standards and cables progress, other current or voltages may be used. In some embodiments, the USB-PD controller 104 periodically updates the PDP 118, for example at a predetermined frequency or when the battery module voltage measurement (V_{BAT}) or the battery temperature measurement (T_{BAT}) are updated. As the battery module 106 discharges and V_{BAT} drops, the PDO current options for the PDP 118 will decrease.

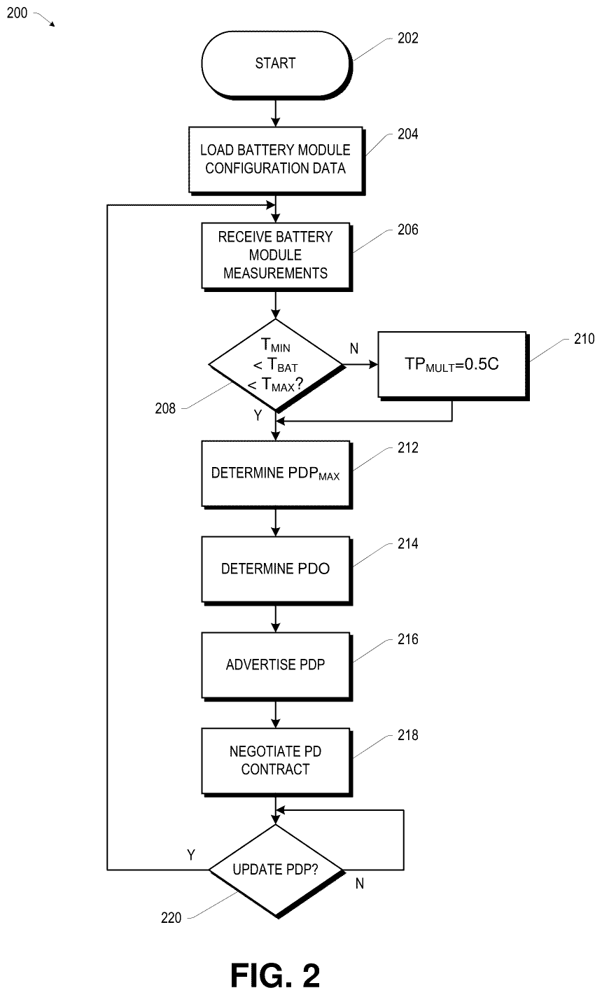

FIG. 2 is a flowchart illustrating a method 200 of operating the dual role power pack 100, in accordance with some embodiments. The method 200 starts at 202. At 204, the USB-PD controller 104 loads the battery module configuration data, for example, from the configuration memory 106M of the battery module 106. At 206, the USB-PD controller 104 receives battery module measurements, for example, voltage or temperature from the sensors 106S of the battery module 106. At 208, the USB-PD controller 104 determines if the battery module temperature is within predetermined limits, for example, T_{MIN}<T_{BAT}<T_{MAX}. If the battery module temperature is outside the predetermined limits at 208, the USB-PD controller 104 applies the temperature protection discharge multiplier (TP_{MULT}) at 210.

At 212, the USB-PD controller 104 determines the maximum source PDP (PDP_{MAX}) based on the battery module configuration data and the battery measurements, for example, as defined above in Equations 1 or 2. At 214, the USB-PD controller 104 determines power delivery options (PDO) based on PDP_{MAX}, for example, as shown above in Equations 5-8. In some embodiments, the PDO currents may be limited by the USB-PD standard or the Type-C Cable connected. At 216, the USB-PD controller 104 advertises a PDP 118 based on the PDO values. The PDP 118 specifies various voltage levels and current levels supported by the USB-PD controller 104 to establish a contract with the external device 116.

At 218, the USB-PD controller 104 negotiates a PD contract with the external device 116 based on the PDP 118. The USB-PD controller 104 controls the regulator circuit 108 to generate the requested PD V_{OUT} at the USB port 102 per the PD contract, to deliver power to the external device 116 (e.g., in order to charge the external device).

At 220, the USB-PD controller 104 determines if the PDP 118 should be updated, for example, if the battery module measurements change or after the expiration of an update timer. The USB-PD controller 104 returns to 206 in the method 200 to update the PDP 118.

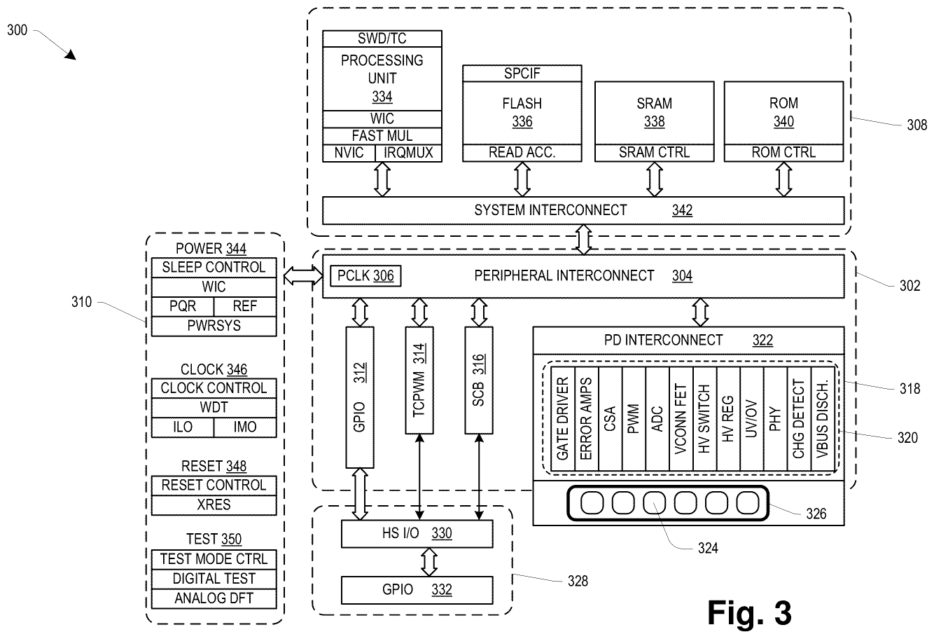

FIG. 3 is a block diagram illustrating a system 300, in accordance with some embodiments. For example, the system 300 may be an integrated circuit (IC) used to implement the USB-PD controller 104. The system 300 may include a peripheral subsystem 302 that includes a number of components for use in USB power delivery. The peripheral subsystem 302 may include a peripheral interconnect 304 including a peripheral clock module (PCLK) 306 for providing clock signals to the various components of the peripheral subsystem 302. The peripheral interconnect 304 may be a peripheral bus, such as a single level or Multi-level Advanced High Performance Bus (AHB), and can provide a data and control interface between the peripheral subsystem 302, a CPU subsystem 308, and system resources 310. The peripheral interconnect 304 may include controller circuitry, such as direct memory access (DMA) controllers, which may be programmed to transfer data between peripheral blocks without input from the CPU subsystem 308, without control of the CPU subsystem 308, or without stressing the same transfer.

The peripheral interconnect 304 may be used to couple the peripheral subsystem 302 components to other components of the system 300. A number of general purpose inputs/outputs (GPIOs) 312 may be coupled to the peripheral interconnect 304 for sending and receiving signals. The GPIOs 312 may include circuitry configured to implement various functions such as pull-up, pull-down, input threshold selection, input and output buffer enable/disable, single multiplexing, and so on. Other functions can also be implemented by the GPIOs 312. One or more timer/counter/pulse width modulators (TCPWM) 314 may also be coupled to the peripheral interconnect and may include circuitry to implement timing circuits (timers), counters, pulse width modulators (PWMs), decoders, and other digital functions associated with I/O signals work and can provide digital signals for system components of the system 300. The peripheral subsystem 302 May also include one or more Serial Communication Blocks (SCBs) 316 for implementing serial communication interfaces such as I2C, Serial Peripheral Interface (SPI), Universal Asynchronous Receiver/Transmitter (UART), Controller Area Network (CAN), CXPI (Clock Extension Peripheral Interface), etc.

The peripheral subsystem 302 may include a PD subsystem 318 (e.g., for USB-PD) coupled to the peripheral interconnect 304 and including a set of modules 320. The modules 320 may be coupled to the peripheral interconnect 304 by a PD interconnect 322. The modules 320 may include: a gate driver module, which may include a buck mode high side gate driver, a buck mode low side gate driver, a boost mode high side gate driver, a boost mode low side gate driver; error amplifiers (AMPS), such as a voltage error amplifier that regulates the output voltage on the VBUS line by PD contract or a current error amplifier that performs slope compensation to facilitate current control; a current sense amplifier (CSA), such as a low side CSA or a high side CSA to measure load current for current control or protection; a PWM module to generate signals for controlling the regulator circuit 108; an analog-to-digital converter (ADC) module for converting various analog signals into digital signals; a VCONN FET module to support active cables, a high voltage switch module, a high voltage (HV) regulator for converting the power source voltage to a precise voltage (such as 3.5-5V) to power the system 300; an under-voltage/over-voltage protection (UV/OV) module; and a communications channel (PHY) module to support communications on a communication channel line (e.g., a USB Type-C communications channel (CC) line). The modules 320 may also include a charger detection module to determine if charging circuitry is present and coupled to the system 300 and a VBUS discharge module to control the discharge of voltage on the VBUS. The VBUS discharge module may be configured to couple to a power source node on the VBUS line or to an output (power sink) node on the VBUS line and adjust the voltage on the VBUS line to the desired voltage level (i.e., the voltage level specified in the contract negotiated voltage level). The power delivery subsystem 318 may also include pads 324 for external connections and Electrostatic Discharge (ESD) suppression circuitry 326. The modules 320 may also include a communication module for retrieving and transmitting information, such as control signals.

The GPIOs 312, the TCPWM 314, and the SCB 316 may be coupled to an input/output (I/O) subsystem 328, which may include a high-speed (HS) I/O matrix 330 connected to a number of GPIOs 332. The GPIOs 312, the TCPWM 314, and the SCB 316 may be coupled to the GPIOs 332 through the HS-I/O matrix 330.

The central processing unit (CPU) subsystem 308 is provided for processing instructions, storing program information and data. The CPU subsystem 308 may include one or more processing units 334 for executing instructions and reading from and writing to memory locations from a number of memories. The processing unit 334 may be a processor suitable for operation in an integrated circuit (IC) or system-on-chip (SOC) device. In some embodiments, the processing unit 334 may be optimized for low power operation with extensive clock gating. In this embodiment, different internal control circuits can be implemented for processing unit operation in different power states. For example, the processing unit 334 may include a single wire debug (SWD) module, a terminal count (TC) module, a wake-up interrupt controller (WIC) configured to wake up the processing unit from a sleep state, which may shut down power when the IC or SOC is in is in a sleep state, a fast multiplier, a nested vector interrupt controller (NVIC), and an interrupt multiplexer (IRQMUX). The CPU subsystem 308 may include one or more memories, including a flash memory 336, a static random access memory (SRAM) 338, and a read only memory (ROM) 340. The flash memory 336 may be non-volatile memory (NAND flash, NOR flash, etc.) configured to store data, programs, and/or other firmware instructions. The flash memory 336 may include system performance controller interface (SPCIF) registers and a read accelerator and, by being integrated into the CPU subsystem 308, improve access times. The SRAM 338 may be volatile memory configured to store data and firmware instructions accessible by the processing unit 334. The ROM 340 may be configured to store boot routines, configuration parameters, and other firmware parameters and settings that do not change during operation of the system 300. The SRAM 338 and the ROM 340 may have associated control circuitry. The processing unit 334 and the memory modules 336, 338, 340 may be coupled to a system interconnect 342 to route signals to and from the various components of the CPU subsystem 308 to other blocks or modules of the system 300. The system interconnect 342 can be implemented as a system bus, such as a single-level or multi-level AHB. The system interconnect 342 may be configured as an interface to couple the various components of the CPU subsystem 308 together. The system interconnect 342 may be coupled to the peripheral interconnect 304 to provide signal paths between the CPU subsystem 308 and components of the peripheral subsystem 302.

The system resources 310 may include a power module 344, a clock module 346, a reset module 348, and a test module 350. The power module 344 may include a sleep control module, a wake-up interrupt control (WIC) module, a power-on-reset (POR) module, a number of voltage references (REF), and a PWRSYS module. In some embodiments, the power module 344 may include circuitry that allows the system 300 to draw power from and/or provide power to external sources at different voltage and/or current levels and control operation in different power states, such as active, low power, or sleep. In various embodiments, more power states may be implemented as the system 300 throttles operation to achieve a desired power consumption or power output. The clock module 346 may include a clock control module, a watchdog timer (WDT), an internal low-speed oscillator (ILO), and an internal main oscillator (IMO). The reset module 348 may include a reset control module and an external reset module (XRES module). The test module 350 may include a module to control and enter a test mode, as well as test control modules for analog and digital functions (digital test and analog DFT).

The system 300 may be implemented as an IC controller (e.g., such as a USB-PD controller 104) in a monolithic (e.g., single) semiconductor die. In other embodiments, different parts or modules of the system 300 may be implemented on different semiconductor dies. For example, the memory modules 336, 338, 340 of the CPU subsystem 308 may be on-chip or off-chip. In still other embodiments, circuitry with separate dies can be packaged in a single “chip” or remain separate and arranged on a circuit board (or in a USB cable connector) as separate elements.

The system 300 can be implemented in a number of application contexts. In any application context, an electronic device may have an IC controller or SOC implementation embodied by the system 300 arranged and configured to perform operations according to the techniques described herein (e.g., the USB-PD controller 104). In one embodiment, the system 300 may be arranged and configured in the dual role power pack 100 that can be charged via a USB Type-A and/or Type-C port and then provide power (e.g., via a USB port 102 and/or the load interface 110) to another electronic device.

It should be understood that a system, such as the system 300, implemented on or as an IC controller, can be placed in various applications that vary in terms of the type of power source used and the direction in which power is supplied. The flow of power input may be from a USB PD adaptor 114 to charge the dual role power pack 100 or from the dual role power pack 100 to a connected device, depending on whether the dual role power pack 100 is operating as a power provider (e.g., to power another device such as the power tool 112, or to charge external device 116) or as a power consumer (e.g., to allow itself to be charged). For these reasons, the various applications of the system 300 should be considered in an illustrative rather than a limiting sense.

In an embodiment of the techniques presented herein, a system comprises a universal serial bus (USB) port, a battery module comprising a configuration memory configured to store battery module configuration data, and a voltage sensor configured to generate a battery module voltage measurement, and a USB power delivery (USB-PD) controller configured to determine a maximum current discharge parameter based on the battery module voltage measurement and the battery module configuration data, determine a power delivery profile based on the maximum current discharge parameter, negotiate a power delivery contract with a device connected to the USB port based on the power delivery profile, and discharge the battery module to provide power from the battery module to the USB port based on the power delivery contract.

In an embodiment of the techniques presented herein, the system comprises a regulator circuit, wherein the battery module configuration data comprises a battery discharge current parameter and a regulator efficiency parameter associated with the regulator circuit, and the USB-PD controller is configured to determine the maximum current discharge parameter based on the battery discharge current parameter and the regulator efficiency parameter, and provide the power from the battery module to the USB port by controlling the regulator circuit to provide power to the USB port based on the power delivery contract.

In an embodiment of the techniques presented herein the battery module comprises a row of battery cells, the battery module configuration data comprises a battery discharge current parameter and a number of battery cells per row parameter, and the USB-PD controller is configured to determine the maximum current discharge parameter based on the battery discharge current parameter and the number of battery cells per row parameter.

In an embodiment of the techniques presented herein, the battery module configuration data comprises a battery discharge current parameter, and the USB-PD controller is configured to determine the maximum current discharge parameter based on the battery discharge current parameter.

In an embodiment of the techniques presented herein, the battery discharge current parameter comprises one of a maximum battery discharge current parameter or a nominal battery discharge current parameter.

In an embodiment of the techniques presented herein, the system comprises a temperature sensor configured to measure a battery module temperature, wherein the battery module configuration data comprises a temperature threshold and a battery discharge current parameter, and the USB-PD controller is configured to determine the maximum current discharge parameter based on the battery discharge current parameter, reduce the maximum current discharge parameter responsive to the battery module temperature violating the temperature threshold to determine a reduced maximum current discharge parameter, and determine the power delivery profile based on the reduced maximum current discharge parameter.

In an embodiment of the techniques presented herein, the system comprises a regulator circuit, wherein the battery module comprises a row of battery cells, the battery module configuration data comprises a battery discharge current parameter, a regulator efficiency parameter associated with the regulator circuit, and a number of battery cells per row parameter, and the USB-PD controller is configured to determine the maximum current discharge parameter based on the battery discharge current parameter, the regulator efficiency parameter, and the number of battery cells per row parameter and provide the power from the battery module to the USB port by controlling the regulator circuit to provide power to the USB port based on the power delivery contract.

In an embodiment of the techniques presented herein, a method for power delivery comprises receiving battery module configuration data from a configuration memory of a battery module, receiving a battery module voltage measurement from a voltage sensor, determining a maximum current discharge parameter based on the battery module voltage measurement and the battery module configuration data, determining a power delivery profile based on the maximum current discharge parameter, negotiating a power delivery contract with a device connected to a universal serial bus (USB) port based on the power delivery profile, and discharging the battery module to provide power from the battery module to the USB port based on the power delivery contract.

In an embodiment of the techniques presented herein, the battery module configuration data comprises a battery discharge current parameter and a regulator efficiency parameter, determining the maximum current discharge parameter comprises determining the maximum current discharge parameter based on the battery discharge current parameter and the regulator efficiency parameter, and discharging the battery module to provide the power from the battery module to the USB port comprises controlling a regulator circuit associated with the regulator efficiency parameter to provide power to the USB port based on the power delivery contract.

In an embodiment of the techniques presented herein, the battery module configuration data comprises a battery discharge current parameter and a number of battery cells per row parameter, and determining the maximum current discharge parameter comprises determining the maximum current discharge parameter based on the battery discharge current parameter and the number of battery cells per row parameter.

In an embodiment of the techniques presented herein, the battery module configuration data comprises a battery discharge current parameter, and determining the maximum current discharge parameter comprises determining the maximum current discharge parameter based on the battery discharge current parameter.

In an embodiment of the techniques presented herein, receiving the battery module configuration data comprises receiving one of a maximum battery discharge current parameter or a nominal battery discharge current parameter as the battery discharge current parameter.

In an embodiment of the techniques presented herein, the method comprises receiving a battery module temperature from a temperature sensor, wherein the battery module configuration data comprises a temperature threshold and a battery discharge current parameter, determining the maximum current discharge parameter comprises determining the maximum current discharge parameter based on the battery discharge current parameter, the method comprises reducing the maximum current discharge parameter responsive to the battery module temperature violating the temperature threshold to generate a reduced maximum current discharge parameter, and determining the power delivery profile comprises determining the power delivery profile based on the reduced maximum current discharge parameter.

In an embodiment of the techniques presented herein, the battery module configuration data comprises a battery discharge current parameter, a regulator efficiency parameter, and a number of battery cells per row parameter, determining the maximum current discharge parameter comprises determining the maximum current discharge parameter based on the battery discharge current parameter, the regulator efficiency parameter, and the number of battery cells per row parameter, and discharging the battery module to provide the power from the battery module to the USB port comprises controlling a regulator circuit associated with the regulator efficiency parameter to provide power to the USB port based on the power delivery contract.

In an embodiment of the techniques presented herein, a universal serial bus power delivery (USB-PD) controller comprises a processing unit configured to receive battery module configuration data associated with a battery module, receive a battery module voltage measurement, determine a maximum current discharge parameter based on the battery module voltage measurement and the battery module configuration data, determine a power delivery profile based on the maximum current discharge parameter, negotiate a power delivery contract with a device connected to a universal serial bus (USB) port based on the power delivery profile, and cause discharge of the battery module to provide power from the battery module to the USB port based on the power delivery contract.

In an embodiment of the techniques presented herein, the battery module configuration data comprises a battery discharge current parameter and a regulator efficiency parameter, and the processing unit is configured to determine the maximum current discharge parameter based on the battery discharge current parameter and the regulator efficiency parameter, and the processing unit is configured to provide the power from the battery module to the USB port by controlling a regulator circuit associated with the regulator efficiency parameter to provide power to the USB port based on the power delivery contract.

In an embodiment of the techniques presented herein, the battery module configuration data comprises a battery discharge current parameter and a number of battery cells per row parameter, and the processing unit is configured to determine the maximum current discharge parameter by determining the maximum current discharge parameter based on the battery discharge current parameter and the number of battery cells per row parameter.

In an embodiment of the techniques presented herein, the battery module configuration data comprises one of a maximum battery discharge current parameter or a nominal battery discharge current parameter, and the processing unit is configured to determine the maximum current discharge parameter based on the maximum battery discharge current parameter or the nominal battery discharge current parameter.

In an embodiment of the techniques presented herein, the processing unit is configured to receive a battery module temperature, the battery module configuration data comprises a temperature threshold and a battery discharge current parameter, and the processing unit is configured to determine the maximum current discharge parameter based on the battery discharge current parameter, reduce the maximum current discharge parameter responsive to the battery module temperature violating the temperature threshold to determine a reduced maximum current discharge parameter, and determine the power delivery profile based on the reduced maximum current discharge parameter.

In an embodiment of the techniques presented herein, the battery module configuration data comprises a battery discharge current parameter, a regulator efficiency parameter, and a number of battery cells per row parameter, and the processing unit is configured to determine the maximum current discharge parameter based on the battery discharge current parameter, the regulator efficiency parameter, and the number of battery cells per row parameter, and provide the power from the battery module to the USB port by controlling a regulator circuit associated with the regulator efficiency parameter to provide power to the USB port based on the power delivery contract.

Various operations of embodiments are provided herein. In an embodiment, one or more of the operations described may constitute computer readable instructions stored on one or more computer readable media, which if executed by an electronic device or system (e.g., such as system 300 in FIG. 3), will cause the device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” and/or the like is used herein to mean serving as an example, instance, illustration, etc., and not necessarily as advantageous. As used herein, “or” is intended to mean an inclusive “or” rather than an exclusive “or”. In addition, “a” and “an” as used in this application can generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system, comprising:
a universal serial bus (USB) port;
a battery module, comprising:
a configuration memory configured to store battery module configuration data; and
a voltage sensor configured to generate a battery module voltage measurement; and
a USB power delivery (USB-PD) controller configured to:
determine a maximum current discharge parameter based on the battery module voltage measurement and the battery module configuration data;
determine a power delivery profile based on the maximum current discharge parameter;
negotiate a power delivery contract with a device connected to the USB port based on the power delivery profile; and
discharge the battery module to provide power from the battery module to the USB port based on the power delivery contract.

2. The system of claim 1, comprising:
a regulator circuit, wherein:
the battery module configuration data comprises a battery discharge current parameter and a regulator efficiency parameter associated with the regulator circuit; and
the USB-PD controller is configured to:
determine the maximum current discharge parameter based on the battery discharge current parameter and the regulator efficiency parameter; and
provide the power from the battery module to the USB port by controlling the regulator circuit to provide power to the USB port based on the power delivery contract.

3. The system of claim 1, wherein:
the battery module comprises a row of battery cells;
the battery module configuration data comprises a battery discharge current parameter and a number of battery cells per row parameter; and
the USB-PD controller is configured to determine the maximum current discharge parameter based on the battery discharge current parameter and the number of battery cells per row parameter.

4. The system of claim 1, wherein:
the battery module configuration data comprises a battery discharge current parameter; and
the USB-PD controller is configured to determine the maximum current discharge parameter based on the battery discharge current parameter.

5. The system of claim 4, wherein:
the battery discharge current parameter comprises one of a maximum battery discharge current parameter or a nominal battery discharge current parameter.

6. The system of claim 1, comprising:
a temperature sensor configured to measure a battery module temperature, wherein:
the battery module configuration data comprises a temperature threshold and a battery discharge current parameter; and
the USB-PD controller is configured to:
determine the maximum current discharge parameter based on the battery discharge current parameter;
reduce the maximum current discharge parameter responsive to the battery module temperature violating the temperature threshold to determine a reduced maximum current discharge parameter; and
determine the power delivery profile based on the reduced maximum current discharge parameter.

7. The system of claim 1, comprising:
a regulator circuit, wherein:
the battery module comprises a row of battery cells;
the battery module configuration data comprises a battery discharge current parameter, a regulator efficiency parameter associated with the regulator circuit, and a number of battery cells per row parameter; and
the USB-PD controller is configured to:
determine the maximum current discharge parameter based on the battery discharge current parameter, the regulator efficiency parameter, and the number of battery cells per row parameter and
provide the power from the battery module to the USB port by controlling the regulator circuit to provide power to the USB port based on the power delivery contract.

8. A method for power delivery, comprising:
receiving battery module configuration data from a configuration memory of a battery module;
receiving a battery module voltage measurement from a voltage sensor;
determining a maximum current discharge parameter based on the battery module voltage measurement and the battery module configuration data;
determining a power delivery profile based on the maximum current discharge parameter;
negotiating a power delivery contract with a device connected to a universal serial bus (USB) port based on the power delivery profile; and
discharging the battery module to provide power from the battery module to the USB port based on the power delivery contract.

9. The method of claim 8, wherein:
the battery module configuration data comprises a battery discharge current parameter and a regulator efficiency parameter;
determining the maximum current discharge parameter comprises determining the maximum current discharge parameter based on the battery discharge current parameter and the regulator efficiency parameter; and
discharging the battery module to provide the power from the battery module to the USB port comprises controlling a regulator circuit associated with the regulator efficiency parameter to provide power to the USB port based on the power delivery contract.

10. The method of claim 8, wherein:
the battery module configuration data comprises a battery discharge current parameter and a number of battery cells per row parameter; and
determining the maximum current discharge parameter comprises determining the maximum current discharge parameter based on the battery discharge current parameter and the number of battery cells per row parameter.

11. The method of claim 8, wherein:
the battery module configuration data comprises a battery discharge current parameter; and
determining the maximum current discharge parameter comprises determining the maximum current discharge parameter based on the battery discharge current parameter.

12. The method of claim 8, wherein:
receiving the battery module configuration data comprises receiving one of a maximum battery discharge current parameter or a nominal battery discharge current parameter as the battery discharge current parameter.

13. The method of claim 8, comprising:
receiving a battery module temperature from a temperature sensor, wherein:
the battery module configuration data comprises a temperature threshold and a battery discharge current parameter;
determining the maximum current discharge parameter comprises determining the maximum current discharge parameter based on the battery discharge current parameter;
the method comprises reducing the maximum current discharge parameter responsive to the battery module temperature violating the temperature threshold to generate a reduced maximum current discharge parameter; and
determining the power delivery profile comprises determining the power delivery profile based on the reduced maximum current discharge parameter.

14. The method of claim 8, wherein:
the battery module configuration data comprises a battery discharge current parameter, a regulator efficiency parameter, and a number of battery cells per row parameter;
determining the maximum current discharge parameter comprises determining the maximum current discharge parameter based on the battery discharge current parameter, the regulator efficiency parameter, and the number of battery cells per row parameter; and
discharging the battery module to provide the power from the battery module to the USB port comprises controlling a regulator circuit associated with the regulator efficiency parameter to provide power to the USB port based on the power delivery contract.

15. A universal serial bus power delivery (USB-PD) controller, comprising:
a processing unit configured to:
receive battery module configuration data associated with a battery module;
receive a battery module voltage measurement;
determine a maximum current discharge parameter based on the battery module voltage measurement and the battery module configuration data;
determine a power delivery profile based on the maximum current discharge parameter;
negotiate a power delivery contract with a device connected to a universal serial bus (USB) port based on the power delivery profile; and
cause discharge of the battery module to provide power from the battery module to the USB port based on the power delivery contract.

16. The USB-PD controller of claim 15, wherein:
the battery module configuration data comprises a battery discharge current parameter and a regulator efficiency parameter; and
the processing unit is configured to determine the maximum current discharge parameter based on the battery discharge current parameter and the regulator efficiency parameter; and
the processing unit is configured to provide the power from the battery module to the USB port by controlling a regulator circuit associated with the regulator efficiency parameter to provide power to the USB port based on the power delivery contract.

17. The USB-PD controller of claim 15, wherein:
the battery module configuration data comprises a battery discharge current parameter and a number of battery cells per row parameter; and
the processing unit is configured to determine the maximum current discharge parameter by determining the maximum current discharge parameter based on the battery discharge current parameter and the number of battery cells per row parameter.

18. The USB-PD controller of claim 15, wherein:
the battery module configuration data comprises one of a maximum battery discharge current parameter or a nominal battery discharge current parameter; and
the processing unit is configured to determine the maximum current discharge parameter based on the maximum battery discharge current parameter or the nominal battery discharge current parameter.

19. The USB-PD controller of claim 15, wherein:
the processing unit is configured to receive a battery module temperature;
the battery module configuration data comprises a temperature threshold and a battery discharge current parameter; and
the processing unit is configured to:
determine the maximum current discharge parameter based on the battery discharge current parameter;
reduce the maximum current discharge parameter responsive to the battery module temperature violating the temperature threshold to determine a reduced maximum current discharge parameter; and
determine the power delivery profile based on the reduced maximum current discharge parameter.

20. The USB-PD controller of claim 15, wherein:
the battery module configuration data comprises a battery discharge current parameter, a regulator efficiency parameter, and a number of battery cells per row parameter; and
the processing unit is configured to:
determine the maximum current discharge parameter based on the battery discharge current parameter, the regulator efficiency parameter, and the number of battery cells per row parameter; and
provide the power from the battery module to the USB port by controlling a regulator circuit associated with the regulator efficiency parameter to provide power to the USB port based on the power delivery contract.
